(19) United States
(12) Patent Application Publication
(10) Pub. No.: US 2012/0319949 A1
(43) Pub. Date: Dec. 20, 2012

(54) POINTING DEVICE OF AUGMENTED REALITY

(76) Inventor: Moon Key Lee, Seoul (KR)

(21) Appl. No.: 13/581,548

(22) PCT Filed: Feb. 28, 2011
(86) PCT No.: PCT/KR2011/001375

§ 371 Date: Aug. 28, 2012

(30) Foreign Application Priority Data
Mar. 1, 2010 (KR) 10-2010-0018300
Mar. 7, 2010 (KR) 10-2010-0020172
Mar. 21, 2010 (KR) 10-2010-0025001

(51) Int. Cl. G06F 3/033

(52) U.S. Cl. 345/158

(57) ABSTRACT

The present invention relates to a pointing device capable of inputting a particular position of augmented reality to a computer. The invention comprises: a camera which takes a picture of a feature point or a mark used to generate an augmented reality image; and an imam processor which recognizes the feature point or the mark taken by the camera, and outputs position information indicative of a particular position in the augmented reality. Mouse cursor images can be synthesized as augmented reality images at the position outputted from the image processor.

### TECHNICAL FIELD

The present invention relates to the pointing device to points a point in augmented reality space.

### BACKGROUND ART

Mouse is widely used pointing device for desktop computer. Joystick is used as a pointing device for playing computer game. These conventional pointing devices are developed to point a point in computer screen. Augmented reality technology provides a scene of real world and virtual.

### DETAILED DESCRIPTION OF THE INVENTION

1. Technical Problem

It is an object of present invention to provide an intuitive and easy pointing device to point a point in augmented reality space.

2. Technical Solution

The present invention comprising:

1st camera to capture image including feature points in order to generate augmented reality scene;
2nd camera to capture the image including the said feature points;
and image processing portion to generate pointing signal by comparing the feature points between the captured images of the said 1st camera and 2nd camera where the pointing point correspond to the intersection point of virtual object in the said augmented reality space and the line of sight(optical axis) of the 2nd camera).

By using the pointing device of present invention like laser pointer, it is very easy and intuitive to select a point in augmented reality space.

### DESCRIPTION OF THE DRAWINGS

FIG. 1 is the embodiment of present invention.

FIG. 2 is the camera and world coordinate system.

FIG. 3 is the other embodiment of present invention with head mound display including camera.

### BEST MODE

The attached drawings for illustrating exemplary embodiments of the present invention are referred to in order to gain a sufficient understanding of the present invention, the merits thereof, and the objectives accomplished by the implementation of the present invention. Hereinafter, the present invention will be described in detail by explaining exemplary embodiments of the invention with reference to the attached drawings. Like reference numerals in the drawings denote like elements

For example, the camera of smart phone can be used to capture the scene to produce augmented reality scene. Such an augmented reality technology is the one that capture the real world, extracting feature points from the captured image, calculating the 3 dimensional relative position and direction between camera and the captured scene and synthesizing virtual 3 dimensional object into the captured image by perspective projection of the virtual object as if the virtual object exist in the real world. The feature points can be corner points of printed rectangle or corner points of natural object or texture. The printed rectangle is used by ArtoolKit which is well known augmented reality software development kit. The augmented reality technology which used the natural feature points is called markerless augmented reality. markerless augmented reality can be found in the thesis “Parallel Tracking and Mapping for small AR Workspaces” by Georg Klein & David Murray (http://www.robots.ox.ac.uk/˜gk/publications/KleinMurray2007ISMAR.pdf). The above thesis explains the technology of extracting feature points from video stream, calculating the camera position from the feature points and synthesizing the augmented reality scene in real time. Feature points of augmented reality of present invention include both of natural and non-natural ones.
augmented reality software includes the following mapping and tracking:
mapping is extracting feature points of mark or corner of object from video stream,
calculating the 3 dimensional position and direction of the feature points from camera
and storing the said 3 dimensional positions and directions as map data;
tracking is calculating the 3 dimensional position(x,y,z) and direction(yaw,pitch,roll)of camera by comparing the feature points of current video stream with the feature points in map data
calculating the camera position from the feature points can be done by function solvePnP of opencv which is well known image processing library. PnP of solvePnP means the perspective N point problem which is an algorithm calculating the camera position from the captured image of n points whose relative position is known and more detail description can be found in http://homepages.inf.ed.ac.uk/rbf/CVonline/LOCAL COPIES/MARBLE/high/pia/solving, htm
present invention does not restricts the algorithm for calculating the camera position and direction.

3 dimensional virtual object located among the feature points can be perspectivly projected by using the camera position and direction which is calculated by the said algorithm or some equivalent one and the projected image of the virtual object can be synthesized with the video streaming. Such projected virtual object can be sensed like real object by human eye.

By using the augmented reality technology, we can see the 3 dimensional character of computer game walking around in real world. Most of present augmented reality technology is focused in the synthesizing the real scene and virtual object by 3 dimensional computer graphics without interaction with user and the virtual object. It is necessary to provide the efficient mean to interact with the virtual object in augmented reality space in order to play game in augmented reality. It is an object of present invention to provide efficient and intuitive pointing device like laser pointer to interact with the virtual object in augmented reality.

### Embodiment 1

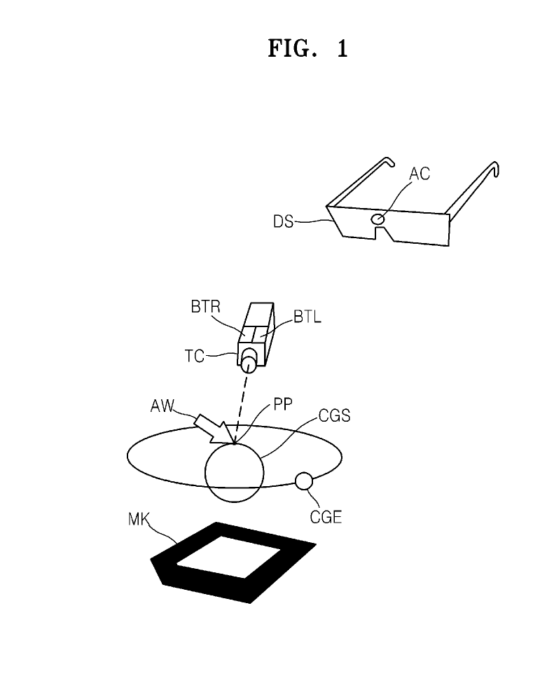

present embodiment explains the pointing device which can be used for augmented reality with artificial mark(MK) in FIG. 1. Using the artificial mark(mk) in present embodiment is only for convenience and it will be fine to use any mark or natural feature in real implementation.

In FIG. 1, the virtual objects(CGS,CGE) generated by computer graphics of augmented reality are earth(CGE) rotating around sun(CGS) and the pointing device of present invention is handheld camera(TC) where the camera's optical axis(line of sight) is pointing the sun(CGS) like laser pointer.

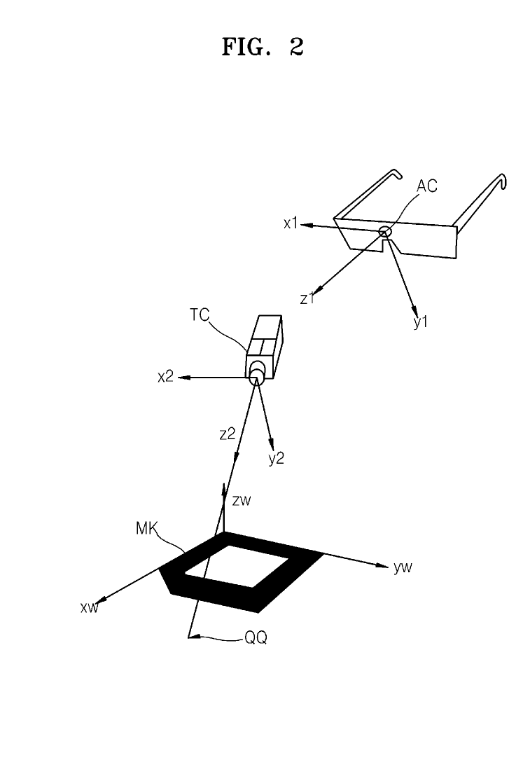

FIG. 2 shows the camera coordinate systems of two cameras(AC,TC) and the world coordinate system of mark(MK).

In FIG. 2, coordinate system of 1st camera(AC) for augmented reality is represented by x1 ,y1 ,z1,

Coordinate system of 2nd camera(TC) for pointing operation is represented by x2,y2,z2,
and the world coordinate system of mark(mk) is represented by xw,yw,zw.

Optical axis(line of sight) of 2nd camera(TC) for pointing operation is z2 axis.

A pointing device of present embodiment comprising:
1st camera (AC) capturing scene of feature points whose shape and size is known(for example, vertex points of rectangle of ar tool kit) as shown in FIG. 1;
2nd camera (TC) capturing the same scene for pointing operation where the position of the 1st and 2nd camera is different;

And image processing portion
recognizing the corresponding feature points between two images where the 1st image is captured by 1st camera and the 2nd image is captured by 2nd camera,
calculating the 3 dimensional relative position and direction between two cameras from the said recognition,
and generating pointing signal based on the said the 3 dimensional relative position and direction between two cameras.
the relative 3 dimensional position and direction between camera and the feature points of mark can be determined by using function “solvePnP” of image processing library “opencv”.

Method for generating pointing signal corresponding to the relative position and direction between two cameras is following:

Calculating the relative 3 dimensional position and direction between mark and the 1st camera by using solvePnP with input image captured by the 1st camera where the image contains mark and the mark size and shape is known.

Similarly Calculating the relative 3 dimensional position and direction between the said mark and the 2nd camera by using solvePnP with input image captured by the 2nd camera where the image contains the same mark.

By using the relative positions and directions of two cameras from the same mark, the relative position and direction between two cameras can be determined and the position and the direction of 2nd camera can be represented in coordinate system of 1st camera.

In FIG. 2, The point(QQ) is the intersecting point of z2 axis(optical axis or line of sight of 2nd camera) and the mark plane(xw-yw plane).

The intersecting point(QQ) can be projected by perspective projection into image of 1st camera and the projected point can be considered as position of pointing cursor in augmented reality space.

If there exist virtual object(CGS) between 2nd camera(TC) and the intersecting point(QQ) as shown in FIG. 1 then the new intersecting point(PP in FIG. 1) can be considered as a position of pointing cursor in augmented reality space and it is recommended to synthesize the virtual mouse cursor image(AW) at the intersecting point(PP) for the augmented reality image.

The image processing portion can recognize the mark(MK) from the image captured by 1st camera and can synthesize the virtual object(CGS,CGE) by using the world coordinate system and perspective projection determined by the detected mark and the synthesize image can be displayed on the display(DS).

It is recommended to make the 2nd camera for pointing operation as a handheld remote controller shaped one with input buttons(BTL,BTR) like left and right mouse button. By adjusting direction of view of the 2nd camera, we can point virtual object(CGS,CGE) of augmented reality space.

It is recommended for the 1st camera(AC) to be included in glasses type display(DS)(head mount display or near eye display) so that the 1st camera can capture the image in the viewing direction(z1 axis direction in FIG. 2) of eye of wearer of the glasses type display(DS). The image processing portion can be a software being executed in smart phone, desktop computer or DSP(digital signal prossor) or some dedicated hardware.

By wearing the glasses type display(DS) including the 1st camera(AC) and controlling the direction of viewing direction of the 2nd camera(TC), we can point arbitrary point in augmented reality space. In other words, changing the direction of view of 2nd camera results in the changing the position(PP in FIG. 1) of virtual mouse cursor(AW). It is possible to select the virtual object by pressing the button of camera(TC) as clicking the mouse button and to move the virtual object in augmented reality space by drag and drop. It is also possible to shoot virtual monster of augmented reality game by triggering button of gun shaped 2nd camera(TC). Camera of smart phone or pc camera can be used as the camera(AC,TC) of present embodiment and the display of smart phone or desktop computer can be used as display(DS) of present embodiment

### Embodiment 2

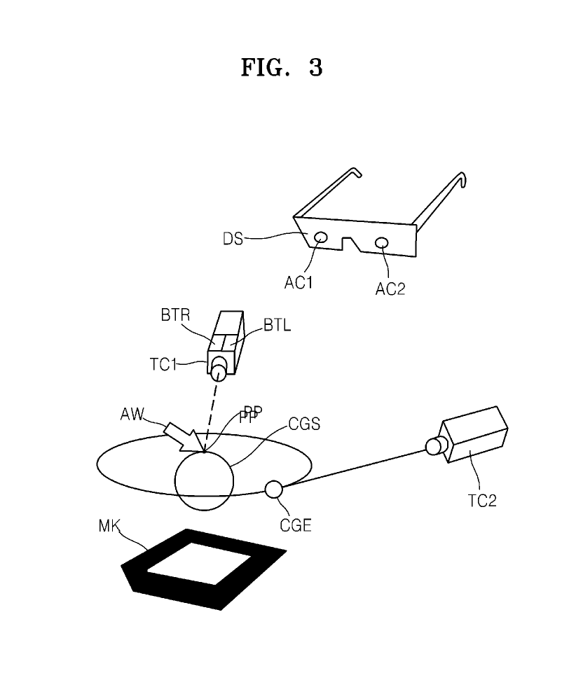

the 1st camera of the above embodiment 1 can be replaced with stereo camera(AC1,AC2) as shown in FIG. 3. In FIG. 3, stereo camera is installed on the glasses type display where the stereo image captured by the stereo camera is displayed on the glasses type display. Such glasses type display with stereo camera can be found on http://www.vuzix.com/consumer/products wrap920ar.html which is a web page for product(W RAP 920AR) of vuzix.

User can also play shooting game with two gun shaped 2nd cameras(TC1,TC2).

### List of Reference Numerals

AC: camera for augmented reality
AC1,AC2: stereo camera
DS: display
TC,TC1,TC2: camera for pointing
BTR,BTL: mouse button
AW: mouse cursor in augmented reality
PP,QQ: position of pointing in augmented reality
CGS,CGE: computer graphical virtual object in augmented reality
MK: mark
x1, y1, z1: coordinate system of 1st camera
x2, y2, z2: coordinate system of 2nd camera
xw, yw, zw: world coordinate system

1. A pointing device comprising:
A 1st camera portion including 1st camera(AC) for capturing 1st image of feature points;
A 2nd camera portion including 2nd camera(TC) for capturing 2nd image of the said feature points;
And an image processing portion for calculating the relative position and direction between the said 1st and 2nd camera by recognizing the feature points of images captured by 1st camera and image captured by 2nd camera.

2. The pointing device of claim 1, wherein
the image processing portion generates pointing signal corresponding to the viewing direction of the said 2nd camera in the field of view of 1st camera where the viewing direction is calculated from the said relative position and direction between 1st and 2nd camera.

3. The pointing device of claim 1, wherein
the image processing portion synthesizes virtual object for augmented reality by using the relative position and direction between the 1st camera and feature points of image captured by 1st camera.

4. The pointing device of claim 2, wherein
the image processing portion synthesizes virtual pointing cursor icon(AW) where the position of virtual pointing cursor icon(AW) corresponds to the pointing signal.

5. The pointing device of claim 1, wherein
the 1st camera portion is a glasses type display with camera capturing image in viewing direction of its wearer.

6. The pointing device of claim 5, wherein
the camera of glasses type display is a stereo camera in front of both eyes of its wearer.

7. A pointing method comprising:
capturing 1st image of feature points for augmented reality;
capturing 2nd image of said feature points for pointing; and
calculating the relative position and direction between 1st and 2nd camera by recognizing the corresponding feature points of 1st and 2nd image;
generating pointing signal corresponding to the viewing direction of 1st camera in field of view of 2nd camera by using the relative position and direction between 1st and 2nd camera.

8. A computer-readable recording medium having stored thereon a computer program for executing a pointing method, wherein the pointing method comprising:
capturing 1st image of feature points for augmented reality;
capturing 2nd image of said feature points for pointing; and
calculating the relative position and direction between 1st and 2nd camera by recognizing the corresponding feature points of 1st and 2nd image;
generating pointing signal corresponding to the viewing direction of 1st camera in field of view of 2nd camera by using the relative position and direction between 1st and 2nd camera.
